(19) United States
(12) Patent Application Publication
(10) Pub. No.: US 2015/0249381 A1
(43) Pub. Date: Sep. 3, 2015

(54) CONTROLLING AN ELECTRICAL CONVERTER

(71) Applicant: ABB Technology AG, Zurich (CH)

(72) Inventors: Alessandro ZANARINI, Baden (CH); Helfried PEYRL, Zurich (CH); Marc-Alexandre BOECHAT, Marly (CH); Thomas BESSELMANN, Birmenstorf (CH)

(73) Assignee: ABB TECHNOLOGY AG, Zurich (CH)

(21) Appl. No.: 14/712,444

(22) Filed: May 14, 2015

Related U.S. Application Data
(63) Continuation of application No. PCT/EP2013/073798, filed on Nov. 14, 2013.

(30) Foreign Application Priority Data
Nov. 15, 2012 (EP) 12192811.3

(51) Int. Cl. H02M 1/08

(52) U.S. Cl. CPC H02M 1/08

(57) ABSTRACT

An exemplary method for controlling an electrical converter includes receiving an actual electrical quantity relating to the electrical converter and a reference quantity; determining a future state of the electrical converter by minimizing an objective function based on the actual electrical quantity and the reference quantity as initial optimization variables; and determining the next switching state for the electrical converter from the future state of the electrical converter. The objective function is iteratively optimized by: calculating optimized unconstrained optimization variables based on computing a gradient of the objective function with respect to optimization variables; and calculating optimization variables for a next iteration step by projecting the unconstrained optimization variables on constraints. The computation of the gradient and/or the projection is performed in parallel in more than one computing unit.

### RELATED APPLICATIONS

This application claims priority under 35 U.S.C. §120 to International application PCT/EP2013/073798 filed Nov. 14, 2013, designating the U.S., and claiming priority to European application 12192811.3 filed on Nov. 15, 2012. The content of each prior application is hereby incorporated by reference in its entirety.

### FIELD

The disclosure relates to a method and a controller for controlling an electrical converter as well as to an electrical converter.

### BACKGROUND INFORMATION

Electrical converters are used for converting a first current, for example a DC current or an AC current of a first frequency, into a second current, for example a further DC or AC current with a further frequency.

For example, power electronic converters, which may be connected to an electrical machine or may be interconnected to electrical grids, usually include a large number of power semiconductors that have to be switched and controlled to generate the desired output current. Besides the minimization of differences between reference quantities and actual determined quantities (such as flux and torque), important objects of the control may be short response times of the controller, low harmonic distortion of the generated current and low switching losses.

Some or all of these objects may be formulated as an objective function that receives as input variables possible future states of the electrical converters and that outputs a cost value that has to be minimized to reach to above mentioned objects.

The future state (include, for example, future switching sequences, future currents, future voltages, etc.) may then be used to determine the next switching state applied to the converter.

As an example, consider model predictive pulse pattern control (MP3C), which is described in more detail in EP 2 469 692 A1. MP3C is a Model Predictive Control (MPC) based method that combines the merits of Direct Torque Control (DTC) and Optimized Pulse Patterns (OPP), two classical and well-established approaches for controlling a motor's torque and flux in medium voltage drive applications. The result may be a control and modulation strategy that yields very short response times during transients, a fast rejection of disturbances, and a nearly optimal ratio of harmonic current distortion per switching frequency at steady-state operation due to the usage of OPPs. The method may be applicable to power electronic converters connected to an electrical machine as well as to the electrical grid.

MP3C inherits its low harmonic current distortion from using pre-computed optimized pulse patterns which may be adapted online to achieve optimal performance during transients. In its original form, the method specifies the solution of a quadratic programme (QP) at every sampling instant to determine the specified corrections of the switching instants of the pre-computed pulse pattern. However, standard QP solvers usually have high computational demands.

MP3C is but one example where a quasi-instantaneous solution of an optimization problem is specified. Another application example may be the control of power electronics converters where the controller computes the modulation index. This may be achieved with a controller cascade with an outer voltage control loop and an inner current control loop both based on MPC. The current controller may call for the solution of a QP while the voltage controller may solve a polynomial optimization problem.

The article “Real-time input-constrained MPC using fast gradient methods,” in Decision and Control, 2009 held jointly with the 2009 28th Chinese Control Conference, CDC/CCC 2009, Proceedings of the 48th IEEE Conference on, 2010, pp. 7387-7393 by S. Richter, C. N. Jones, and M. Morari, shows fast gradients methods for computing the optimum cost value for a class of objective functions.

### SUMMARY

An exemplary method for controlling an electrical converter is disclosed, the method comprising: receiving an actual electrical quantity relating to the electrical converter and a reference quantity; determining a possible future state of the electrical converter by minimizing an objective function based on the actual electrical quantity and the reference quantity; and determining the next switching state for the electrical converter from the possible future state of the electrical converter; wherein the objective function is iteratively optimized by: calculating optimized unconstrained optimization variables based on computing a gradient of the objective function with respect to optimization variables; and calculating optimization variables for a next iteration step by projecting unconstrained optimization variables on constraints, wherein the computation of the gradient and/or the projection is performed in parallel in more than one computing unit.

### BRIEF DESCRIPTION OF THE DRAWINGS

The subject matter of the disclosure will be explained in more detail in the following text with reference to exemplary embodiments which are illustrated in the attached drawings.

FIG. 1 schematically shows an electrical converter according to an exemplary embodiment of the present disclosure.

FIG. 2 shows a flow diagram for a method for controlling a converter according to an exemplary embodiment of the present disclosure.

FIG. 3 schematically shows a controller with an FPGA according to an exemplary embodiment of the present disclosure.

FIG. 4 shows a diagram explaining the operation of the FPGA of FIG. 3 according to an exemplary embodiment of the present disclosure.

FIG. 5 schematically shows a controller with a multi-core processor according to an exemplary embodiment of the present disclosure.

FIG. 6 shows a diagram explaining the operation of the controller of FIG. 5 according to an exemplary embodiment of the present disclosure.

In principle, identical parts are provided with the same reference symbols in the figures.

### DETAILED DESCRIPTION

Exemplary embodiments of the present disclosure provide controllers and control methods that have short response times, that produce low harmonic distortion and that generate low switching losses.

An exemplary embodiment of the present disclosure relates to a method for controlling an electrical converter, for example a medium voltage converter, which may be a DC-to-AC, an AC-to-DC or AC-to-AC converter. The method may be implemented in a controller of the electrical converter, for example an FPGA or DSP. The electrical converter may be part of a system including the electrical converter and an electrical machine such as an electrical motor or electrical generator. However, the electrical converter may also connect a first electrical grid with a second electrical grid.

According to an exemplary embodiment of the present disclosure, the method includes the steps of: receiving an actual electrical quantity of the electrical converter and a reference quantity; determining at least one possible future state (or a plurality of possible future states) of the electrical converter by minimizing an objective function based on the actual electrical quantity and the reference quantity; and determining the next switching state for the electrical converter from the possible future state(s) of the electrical converter.

The control method may be a loop control method, which may minimize a difference between one or more actual electrical quantities (for example, an actual output current, an actual output voltage, an actual flux and/or an actual torque), which may be measured or indirectly determined from measured quantities, and reference quantities (for example, a reference output current, a reference output voltage, a reference flux, a reference actual torque).

Furthermore, the control method may minimize further control objectives as described above. All the control objectives may be encoded in an objective function, which maps quantities like predicted states and inputs as optimization variables to a cost value. The electric quantities may be the actual and reference quantity and further quantities of a future state of the converter and/or the system, which, for example, may include future voltages, currents, fluxes, torques, switching states of semiconductor switches, etc.

The objective function and/or the future state may be based on a physical model that may be derived from the setup of the electrical converter and/or the overall electrical system.

In each control cycle, the control method determines a next switching state for the semiconductor switches of the electrical converter by choosing the future state, which yields to an objective function with the optimal (e.g., lowest) cost value.

The objective function is iteratively optimized by: calculating optimized unconstrained optimization variables based on computing a gradient of the objective function with respect to optimization variables; and calculating optimization variables for a next iteration step by projecting the unconstrained optimization variables on constraints. For example, the objective function may be calculated with the fast gradient method as described in the article of Richter et al.

The computation of the gradient and/or the projection is performed in parallel in more than one computing unit. A computing unit may be a unit or part of an FPGA or a core of a multi-core-processor. A multi-core processor may include more than one processor on one chip or may include several processors on different chips.

For example, the computation of the gradient may be performed in parallel in more than one computing unit. Alternatively or additionally, the computation of the gradient may be performed in parallel to the projection. The computation of the gradient and/or the projection may be performed in parallel threads and/or may be pipelined.

According to an exemplary embodiment of the disclosure, the iteration further includes: grouping the optimization variables into groups, such that each group of optimization variables is projectable separately from the other groups. The electrical quantities may be grouped with respect to electrical phases of the electrical converter and/or into physical similar or equal quantities, for example into currents, voltages, switching states, fluxes, etc. Furthermore, the grouping may be done with respect to the projection, such that each group may be projected independent or separately from each other. The grouping may also be done with respect to sub-matrices of a matrix used for calculating the gradient, wherein the sub-matrices are substantially independent from each other (e.g., there may be only few matrix entries outside of the sub-matrices).

The computation of the gradient and/or the projection of the unconstrained optimization variables may be performed in parallel for each group using several computing units of the controller. In such a way, nearly no intercommunication between the computing units may be specified.

According to an exemplary embodiment of the disclosure, the optimized unconstrained optimization variables are calculated by adding the negative and/or appropriately scaled gradient of the objective function to the optimization variables. In other words, the optimization variables may be optimized by stepping in anti-gradient direction towards the optimum.

According to an exemplary embodiment of the disclosure, the iteration comprises scaling the constrained optimization variables by scaling factors. For example, the difference between the projected (e.g., constrained) optimized optimization variables and the optimization variables of the previous iteration step may be scaled by the scaling factors, to tune the calculation of the optimized optimization variables, as described below. The scaling may be performed in more than one computing unit of the controller. The scaling may be performed in parallel to at least one of the gradient calculation and the projection.

According to an exemplary embodiment of the disclosure, the gradient of the objective function includes a matrix multiplied by a vector of optimization variables. This may be the case, when the objective function constitutes a quadratic programming problem.

According to another exemplary embodiment of the disclosure, a multiplication of entries of a column of the matrix with optimization variables is performed in parallel in more than one computational unit. This may be suitable for executing of the iterations in an FPGA, since the computations may be pipelined by performing calculation in parallel for each column of the matrix.

According to an exemplary embodiment of the disclosure, a multiplication of entries of a row of the matrix with optimization variables is performed in parallel in more than one computational unit. This may be suitable for a parallel executing of the iterations in different threads, since there may be only little inter-thread communication.

According to yet another exemplary embodiment described herein, the method may include the steps of: determining a sequence of future switching states by minimizing the objective function; and using the first future state from the sequence of future switching states as the next switching state to be applied to the electrical converter. The control method may be based on a moving horizon, e.g., future states for not only the next but a number (horizon) of future control cycles may be determined in every cycle.

A further aspect of the disclosure relates to a controller for an electrical converter, wherein the controller is adapted (e.g., configured) for executing the method as described in the above and in the following. It has to be understood that features of the method as described in the above and in the following may be features of the controller as described in the above and in the following and vice versa.

The controller may include the computing units, which are used for executing the above mentioned method steps in parallel. The controller may also include an field programmable gate array (FPGA), central processing Unit (CPU) and/or graphics processing unit (GPU) for providing the computing units.

The part of the controller solving the optimization may be implemented on an FPGA or a multi-core based control system, which has been programmed to admit the actual quantities (e.g., system measurements) and other control problem parameters (e.g., of the future state) as inputs, execute the called for calculations and return the manipulated variables that describe the control inputs.

According to an embodiment of the disclosure, the controller includes an FPGA, which includes at least one of: at least one matrix multiplication unit for multiplying the optimization variables with a matrix; at least one a projection unit for projecting the unconstrained optimization variables; at least one scaling unit for scaling the constrained optimization variables by scaling factors.

The computations may be performed in parallel in at least two matrix multiplication units, at least two projection units and/or at least two scaling units. The computations may be pipelined such that they are performed in parallel in a matrix multiplication unit, a projection unit and/or a scaling unit.

The gradient-based optimization method may be implemented in an FPGA for solving optimization problems in the microsecond range. Combining the algorithmic advantages of gradient-based algorithms in MPC applications with the computational strengths of an FPGA implementation may allow solving a quadratic programming problem of MP3C with large prediction horizons optimally, which may result in improved control performance, e.g., torque and stator flux may be kept close to their references during transients while the harmonic current distortion is at its physical minimum.

The controller may have a hybrid architecture, such as a combination of a CPU and an FPGA (e.g., on the same chip). For example, the matrix-vector multiplication is done on an FPGA, and then (possibly complicated) projections are performed on a CPU.

If the control system is combined with an FPGA, the CPU or DSP of the controller may set up the control problem by writing the data called for on pre-defined memory positions. The FPGA may either directly measure/estimate the actual quantities and may solve the resulting MPC problem, or may receive these values from the DSP/CPU. Similarly, the FPGA may either directly transmit the optimal control actions to a modulator, or return the result of the calculation to the DSP/CPU for further processing.

According to an exemplary embodiment of the present disclosure, the gradient of the objective function includes a vector part that is based on a matrix equation of the actual quantity and/or the reference quantity. The matrix multiplication unit may be used for calculating the vector part before calculating the unconstrained optimization variables. The vector part may have to be calculated once in each cycle from the actual and/or reference quantities. To save independent computation units, a matrix multiplication unit already used for calculation the matrix vector multiplication of the objective function may also calculate the matrix vector multiplication of the vector part.

According to an exemplary embodiment of the present disclosure, the controller includes a multi-core processor, wherein the controller is adapted (e.g., configured) for executing the computation of the gradient and/or the projection for groups of optimization variables in parallel in more than one core of the multi-core processor. The computation of the gradient, the projection and/or the scaling for one group of optimization variables may be performed in one thread, which is executed in one of the cores.

A further aspect of the disclosure relates to an electrical converter having a controller as described in the above and in the following.

These and other aspects of the disclosure will be apparent from and elucidated with reference to the embodiments described hereinafter.

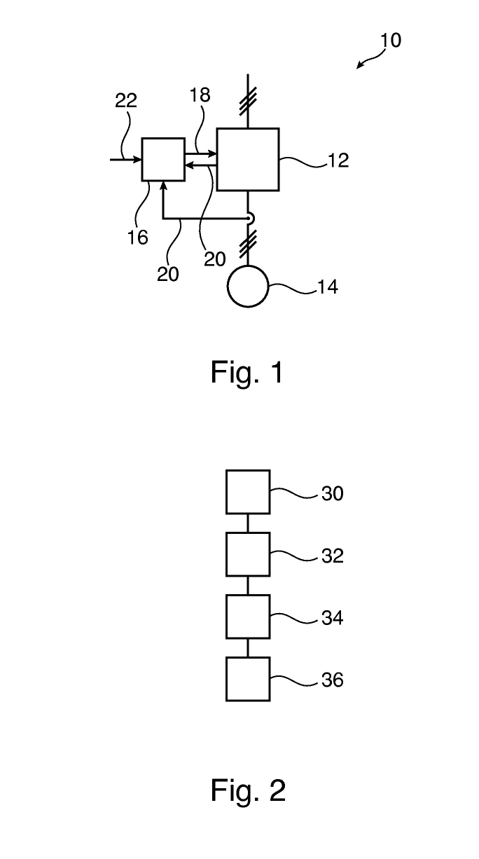

FIG. 1 schematically shows an electrical converter according to an exemplary embodiment of the present disclosure. As shown in FIG. 1, a system 10 includes an electrical converter 12 that may be a power electronics converter like a modular multi-level converter or any other type of converter. In the example shown in FIG. 1, the converter 12 converts a three-phase input current into a three-phase output current. However, any other type of configuration may be possible, such as a DC-to-AC converter or an AC-to-DC converter.

The system 10 includes a load 14 that is supplied by the electrical converter 12, for example an electrical machine 14 or a further electrical grid 14.

For switching the currents, the converter 12 has a large number of semiconductor switches that are controlled by a controller 16.

The controller 16 calculates the next switching state 18 that has to be applied to the converter 12. The next switching state 18 is determined from actual electrical quantities 20 of the system 10 and one or more reference quantities 22 based on the minimization of an objective function that encodes the control objectives of the electrical system 10.

The actual electrical quantities 20 may include measurements and/or estimations and may stem from the electrical converter 12, the load (e.g., machine or grid) 14, and/or from the electrical network supplying the electrical converter 12.

FIG. 2 shows a flow diagram for a method for controlling a converter according to an exemplary embodiment of the present disclosure

In step 30, the controller 16 receives one or more actual electrical quantities, for example from measurement devices attached to the controller 16 or the load 14, and one or more reference quantities 22.

The actual electrical quantities 20 may include measured currents, for example at the output of the converter 12 or inside of the converter 12, measured voltages measured at the output of the converter 12 or inside of the converter, the flux and the torque in an electrical machine.

The reference quantities 22 may have a reference current, a reference voltage, a reference flux and so on.

In step 32, from the actual quantities 20 and the reference quantities 22, the controller 16 determines one or more future states of the converter 12, which may include future switching states and/or future electrical quantities.

For example, the controller 12 may determine a sequence of future electrical quantities by generating a sequence of possible future switching states and deriving the future electrical quantities therefrom. In this step, a model of the converter 12 and/or the load 14 may be used for calculating the future electrical quantities.

As another example, the controller 16 may determine a pre-calculated pulse pattern as future switching state as described in EP 2 469 692 A1.

In step 34, the controller 16 optimizes (for example minimizes) an objective function for determining the future state with an optimal cost value. The objective function is a function mapping the future states to a cost value.

For example, the objective function may minimize the difference between future electrical quantities and the reference quantities by also minimizing harmonic distortions in the input and/or output currents and/or by minimizing the switching losses of the converter 12.

The objective function may be derived from the setup of the system and physical laws.

In step 36, the next switching state is determined from a future state with optimized objective function.

For example, the controller 16 may include a modulator, which receives a reference voltage based on the optimized future state and a further controller determines the next switching state from the reference voltage.

As a further example, when the future states includes a sequence or series of future states, a moving horizon policy may be used and only the switching state of the next future state may be chosen.

In the following, the optimization of the objective function f(z) in step 34 will be explained in more detail. In many cases, the objective function f(z) is a polynomial function of its input variables z, e.g., may be the values of the actual state and the future states of the system 10.

The above mentioned optimization problem may be formulated as a continuous optimization problem of the form

$${min}_{z} f ( z ) s . t . z ∈ Z$$

with the optimization variable zε [symbol] ⁿ^{_{z}}, objective function f(z) and the constraint set Z=Z₁×Z₂× . . . ×Z_{N} resembling the Cartesian product of simple sets. A set may be called simple, if the projection (see below) of a point onto the set is computationally lightweight in comparison to solving the original optimization problem. A simple set may be seen as a group of constraints that are interrelated with each other.

For example, due to the form of the physical laws (such as Kirchhoff's laws), the objective function is often quadratic, which yields to a quadratic optimization problem of the form

$${min}_{z} {z}^{T} Hz + {g}^{T} z s . t . z ∈ Z$$

where Hε [symbol] ⁿ^{_{z}}^{×n}^{_{z}} is a symmetric positive semidefinite matrix, gε [symbol] ⁿ^{_{z}} a vector.

As will become important in the following, the gradient ∇f(z) of this quadratic objective function is given by 2 Hz+g.

In the article of Richter et al., mentioned in the beginning, two possible methods for solving the problems above for MPC applications were proposed: the gradient and the fast gradient method.

The fast gradient method is restated here as an algorithm. The algorithm specifies an initial point z₀εZ, y₀=z₀ as input variable, the number of iterations iₘₐₓ, the Lipschitz constant L and scaling factors β₀, . . . , βᵢₘₐₓ₋₁.

$$for i = 0 : {i}_{max - 1} do$$

$${\tilde{z}}_{i + 1} = {y}_{i} - \frac{1}{L} ∇ f ( {y}_{i} ) = {y}_{i} - \frac{1}{L} ( 2 {Hy}_{i} + g ) = {My}_{i} + \tilde{g}$$

$${z}_{i + 1} = {Π}_{z} ( {\tilde{z}}_{i + 1} )$$

$${y}_{i + 1} = {z}_{i + 1} + {β}_{i} ( {z}_{i + 1} - {z}_{i} )$$

$$end for$$

The algorithm optimizes the variables z with respect to the objective function f(z).

In the first line in the iteration loop, the algorithm calculates unconstrained optimization variables \tilde{z}ᵢ₊₁ from the previously calculated optimization variables yᵢ during the previous iteration step. This is done by stepping in the anti-direction of the radient ∇f(z).

In the second line in the iteration loop, the algorithm projects the unconstrained optimization variables \tilde{z}ᵢ₊₁ onto constrained optimization variables zᵢ₊₁.

In the third line in the iteration loop, the algorithm scales the constrained optimization variables zᵢ₊₁ by the scaling factors β₀, . . . , βᵢₘₐₓ₋₁ to calculate the optimization variables yᵢ₊ᵢ for the next iteration step. By scaling the optimization variables, the step in the anti-direction of the gradient ∇f(z) may be corrected.

The symbol Π_{Z} denotes the projection on the constraint set Z For example, some of the future states are restricted to certain bounds or may only comprise discrete values. In these cases the projection Π_{Z} may restrict the unconstrained values \tilde{z} to the constrained values z by restricting them to the bounds and/or by setting them to the next allowed discrete value.

In an MPC problem, the optimization variables z usually represent the control inputs after the state predictions have been eliminated using the state update equations. The sets Zᵢ can then represent the constraints on the control inputs over the prediction horizon. In the presence of state constraints, the elimination of the state predictions can produce constraint sets Zᵢ which are not simple any more. However, it may be still possible to solve the MPC problem with a gradient method via the nested solution of optimization problems having only simple sets. Consequently, the provided method may also be used for the solution of general MPC problems with state constraints or soft-constraints on states/inputs.

Furthermore, note that in an MPC setup, the vector g is often a function of the current measured (or estimated) actual quantities and the reference quantities, and consequently should be updated in each cycle of the control loop.

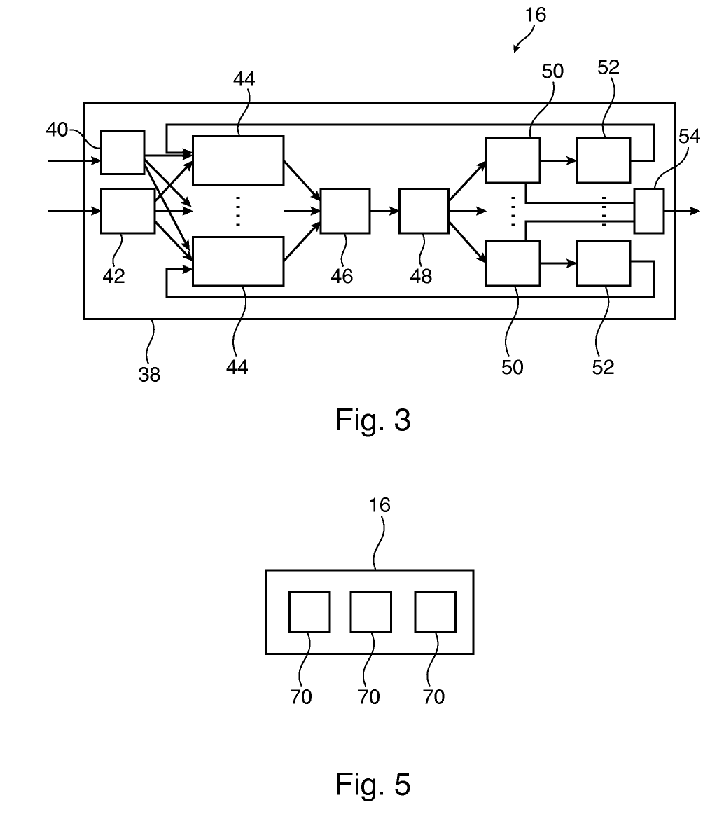

The above described control method using the optimization algorithm for optimizing the objective function may be implemented in an FPGA (see FIG. 3) or a multi-core controller (see FIG. 5) in the following ways.

The optimization variables z are grouped into N groups, z=[z₁^{T} z₁^{T} . . . z_{N}^{T}], where zᵢε [symbol] ⁿ^{_{z}}, Σnᵢ=n_{z}. The sizes nᵢ of the groups may be equal. However, it may be possible that the sizes of all groups are not equal.

According to an exemplary embodiment of the present disclosure, all elements of one group are subject to one simple set zⱼεZⱼ, but also other groupings such as single elements or the whole set of optimization variables in one group are possible.

The following discussion will focus on a quadratic programming problem with a quadratic objective function f (z)=z^{T} Hz+g^{T} z.

Using the partitioning, the matrix-vector multiplication for the computation of the gradient step can be stated as

$$Mz = [ \begin{matrix}{c}_{1} & {c}_{2} & … & {c}_{N}\end{matrix} ] [ \begin{matrix}{z}_{1} \\ {z}_{2} \\ ⋮ \\ {z}_{N}\end{matrix} ]$$

where each cⱼ denotes a set of nᵢ column vectors of the matrix M=I−2/LH.

This partitioning may be useful for an implementation in an FPGA.

FIG. 3 schematically shows a controller with an FPGA according to an exemplary embodiment of the present disclosure. Namely, FIG. 3 shows a controller 16 with an FPGA 38 that has a number of computational units, e.g., a data input unit 40, a matrix unit 42, one or more matrix multiplication units 44, an adder tree unit 46, a buffer unit 48, a number of projection units 50, and a number of beta units 52 and a data output unit 54 that implement the algorithm shown above.

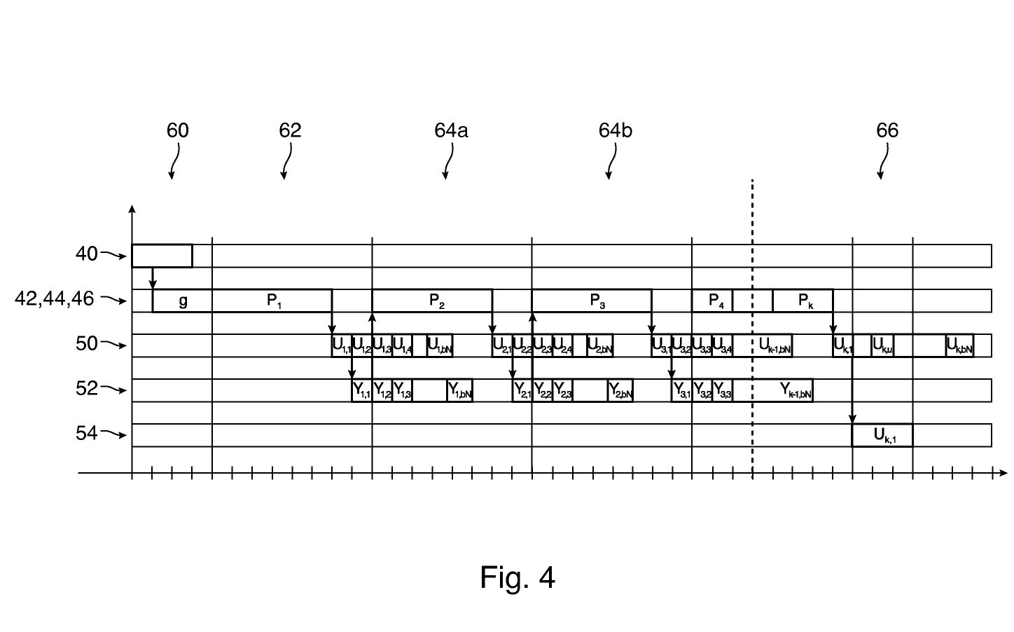

FIG. 4 shows a diagram explaining the operation of the FPGA of FIG. 3 according to an exemplary embodiment of the present disclosure. The operation of the FPGA 40 will be explained with respect to FIG. 4 showing a Gantt chart of a possible implementation of the fast gradient method (Algorithm) on an FPGA.

The horizontal lines represent the computation units: a data input unit 40, a matrix unit 42, matrix-vector multiplication unit 44 and adder tree unit 46, projection unit 50, beta units 52 and data output unit 54. The horizontal axis represents the time, each notch indicating one clock cycle. The boxes indicate use of the respective computation unit, while the arrows visualise data transfer from one computation unit to another.

In section 60, the vector part \tilde{g} of the gradient of the objective function f(z) is calculated. The component \tilde{g} of the gradient depends on the actual and reference quantities of the converter 12 and/or load 14 and has to be computed every cycle of the controller 16 (in which all iterations for optimizing the objective function are performed).

Usually, \tilde{g} is based on a matrix equation and the matrix multiplication units 44 may be used for calculating \tilde{g}. In section 60, the respective matrix for \tilde{g} is loaded into the matrix multiplication units 44 by the matrix unit 42. Furthermore, the input data unit loads 40 loads the actual and reference quantities into the matrix multiplication units 44.

Also in section 60, the initial values of the optimization variables z may be loaded into the matrix multiplication unit 44.

In section 62, the first iteration is performed by the matrix multiplication units 44 to compute cⱼzⱼ and by the adder tree unit 46 to add the result to a register or buffer unit 48 (in which g is already stored, alternatively \tilde{g} can be stored in the matrix multiplication units 44).

If only one matrix multiplication unit 44 is used, at each clock cycle one group zᵢ is passed to this unit, such that after N clock cycles, Mz+\tilde{g} is obtained. More than one matrix multiplication units 44 may be used for calculating more than one group in each clock cycle.

At the end of section 62, the first group of optimization variables zᵢ is projected by the constraint projection units 50 onto the respective constraints and the result is scaled by the beta units 52.

When the first group zᵢ has been scaled, the matrix multiplication units 44 already may start again to perform the next iterations. During these calculations, the next groups of optimization variables are projected and scaled in parallel and then passed to the matrix multiplication units 44.

If the elements of the optimization vector z are grouped such that each group zᵢ can be projected separately, it is possible to increase the utilization of the computation units of the FPGA 38 by pipelining the groups zᵢ through the computational units and thus to save space on the FPGA without a big delay in processing time.

In section 64a, 64b, etc. further iterations are performed. When the limit of iₘₐₓ iterations has been reached, in section 66, the data output unit 54 reads out the result. Note that in the case of a moving horizon, the data output unit may should read out only the first elements of the optimized variables z, which contain the next future state of the converter 12.

As an alternative, the matrix-vector multiplication may be carried out not as column-scalar multiplication but as a row-vector multiplication:

$$Mz = [ \begin{matrix}{r}_{1} \\ {r}_{2} \\ ⋮ \\ {r}_{N}\end{matrix} ] z$$

where rᵢ is a set of nᵢ rows of M. The row-vector formulation may be appealing for multi-core platforms as the amount of inter-core communication is lower than in the column scalar approach.

FIG. 5 schematically shows a controller with a multi-core processor according to an exemplary embodiment of the present disclosure. Namely, FIG. 5 shows a controller 16 that includes a plurality of single-core processors 70, which may be seen as other types of computing unit 70 of the controller 16 (compared to the computing units 40 to 54 of the FPGA 38).

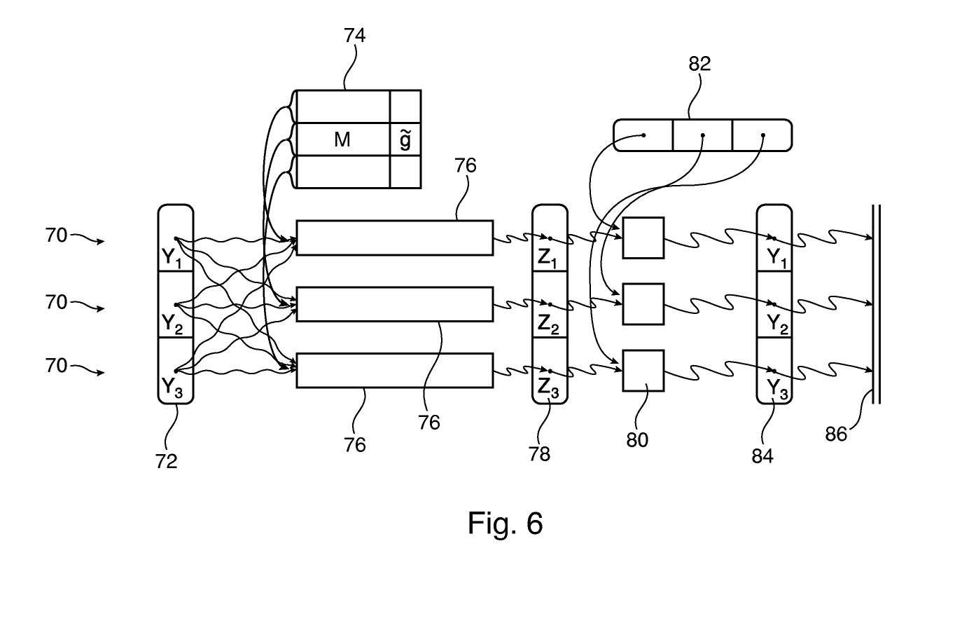

FIG. 6 shows a diagram explaining the operation of the controller of FIG. 5 according to an exemplary embodiment of the present disclosure. Namely, FIG. 6 shows a diagram with functional modules and buffers that are executed on the controller of FIG. 5. The arrows indicate the flow of data between the blocks.

In a first step, the initial values for the optimization variables are stored in an input buffer 72. As indicated in FIG. 6, the optimization variables yᵢ are grouped into three groups. However, any other number of groups is also possible.

Furthermore, the entries of the matrix M and the vector \tilde{g} are stored in a matrix buffer 74.

After that, a gradient and projection module 76 is executed in the cores 70 in parallel. The rows of the matrix buffer 74 associated with the respective group of optimization variables zᵢ is loaded from the matrix buffer 74 and multiplied with all variables from the buffer 72 and projected to calculate the optimized optimization variables zᵢ, which are stored in a buffer 78.

After the respective variables zᵢ have been calculated, a scaling module 80 is executed in each core 70, which calculates the scaled optimization variable yᵢ for the next iteration step. In this step, the optimized variables zᵢ from the last step are loaded from a buffer 82.

At the end of the iteration, all cores have to wait for a thread barrier 86 to synchronize the execution of the next iteration.

The buffers 72, 84 may be implemented as a read buffer 72 and a write buffer 84 with two pointers that are swapped at the thread barrier to avoid unnecessary copying.

Another embodiment is the implementation of a gradient-based method for the solution of more general optimization problems. Instead of a quadratic objective function f(z), f(z) may be a general differentiable objective function, with the gradient ∇f(z). The (fast) gradient method employed on a non-convex differentiable objective function does not guarantee convergence to the global minimum but rather to a local minimum. An implementation on an FPGA is still possible albeit the pipelining of the computational units 50 to 54 described above should be adapted to the structure of the problem at hand. For simplicity, we assume that zᵢ are scalars noting it is straight-forward to extend the presented discussion to non-scalar partitions.

If f(z) is a multivariate polynomial of degree d, the gradient ∇f(z) includes n_{z} polynomials with a maximum degree of d−1. As an explanatory example, consider a polynomial objective function f(z)=z₁²z₂²+z₁²z₂+z₁z₂² with gradient as follows:

$$∇ f ( z ) = ( \begin{matrix}2 {z}_{1} {z}_{2}^{2} + 2 {z}_{1} {z}_{2} + {z}_{2}^{2} \\ 2 {z}_{1}^{2} {z}_{2} + {z}_{2}^{2} + 2 {z}_{1} {z}_{2}\end{matrix} )$$

For example, a parallel implementation may proceed by computing row by row the gradient evaluation.

To accelerate the computation and save space on an FPGA or multi-core processor, the evaluation unit may reuse multiplication results for example by applying a multivariate Horner scheme.

For illustration, consider the polynomial 2z₁ z₂²+2z₁ z₂+z₂² of the example presented earlier. A naive implementation of the polynomial evaluation would call for 6 multipliers. Instead, by using a simple Horner scheme, we can rewrite it as: z₂(z₂(2z₁+1)+2z₁) leading therefore to 4 multiplications. Moreover, the term 2z₁ may be computed just once decreasing to a total number of multiplications to 3. Aside from the lower number of operations specified, a Horner scheme allows also to reuse the same multiplier and adder unit.

Given the specificity of the problem, this approach can be further tailored so that intermediate results of the Horner scheme can be reused for the next polynomial evaluations.

Considering again the example, an intermediate result of the evaluation of the Horner scheme for the first polynomial is 2z₁z₂+z₂. Instead of developing completely the Horner scheme also for the second polynomial, a solution could simply compute z₁(2z₁z₂+2z₂+z₁) by reusing 2z₁z₂+z₂ adding z₁+z₂ and employ a single multiplier.

Such approaches may be employed for a general differentiable objective function.

While the disclosure has been illustrated and described in detail in the drawings and foregoing description, such illustration and description are to be considered illustrative or exemplary and not restrictive; the disclosure is not limited to the disclosed embodiments. Other variations to the disclosed embodiments can be understood and effected by those skilled in the art and practising the claimed disclosure, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for controlling an electrical converter, the method comprising:
receiving an actual electrical quantity relating to the electrical converter and a reference quantity;
determining a possible future state of the electrical converter by minimizing an objective function based on the actual electrical quantity and the reference quantity; and
determining the next switching state for the electrical converter from the possible future state of the electrical converter;
wherein the objective function is iteratively optimized by:
calculating optimized unconstrained optimization variables based on computing a gradient of the objective function with respect to optimization variables;
calculating optimization variables for a next iteration step by projecting unconstrained optimization variables on constraints;
wherein the computation of the gradient and/or the projection is performed in parallel in more than one computing unit.

2. The method of claim 1, wherein the computation of the gradient is performed in parallel in more than one computing unit.

3. The method of claim 1, wherein the computation of the gradient is performed in parallel to the projection.

4. The method of claim 1, wherein the iteration comprises:
grouping the optimization variables into groups, such that each group of optimization variables is projectable separately from the other groups,
wherein the computation of the gradient and/or the projection of the unconstrained optimization variables is performed in parallel using several computing units of the controller.

5. The method of claim 1,
wherein the iteration includes scaling the constrained optimization variables by scaling factors;
wherein the scaling is performed in more than one computing unit and/or wherein the scaling is performed in parallel to at least one of the gradient calculation and the projection.

6. The method of claim 1,
wherein the gradient of the objective function includes a matrix multiplied by a vector of optimization variables.

7. The method of claim 6, wherein a multiplication of entries of a column of the matrix with optimization variables is performed in parallel in more than one computational unit.

8. The method of claim 6, wherein a multiplication of entries of a row of the matrix with optimization variables is performed in parallel in more than one computational unit.

9. The method of one of claim 1, wherein the optimized unconstrained optimization variables are calculated by adding the negative gradient of the objective function to the optimization variables.

10. The method of one claim 1, further comprising:
determining a sequence of future switching states by minimizing the objective function;
using the first future state from the sequence of future switching states as the next switching state to be applied to the electrical converter.

11. A controller for an electrical converter, wherein the controller is configured for executing the method of claim 10.

12. The controller of claim 11 having an FPGA, the FPGA comprising at least one of:
at least one matrix multiplication unit for multiplying the optimization variables with a matrix;
at least one projection unit for projecting the unconstrained optimization variables; and
at least one scaling unit for scaling the constrained optimization variables by scaling factors.

13. The controller of claim 12, wherein the gradient of the objective function includes a vector part that is based on a matrix equation of the actual quantity and/or the reference quantity,
wherein the matrix multiplication unit is used for calculating the vector part before calculating the unconstrained optimization variables.

14. The controller of claim 11, comprising:
a multi-core processor,
wherein the controller is configured for executing the computation of the gradient and/or the projection for groups of optimization variables in parallel in more than one core of the multi-core processor.

15. An electrical converter comprising a controller according to claim 14.
